(19) United States
(12) Patent Application Publication
(10) Pub. No.: US 2013/0063458 A1
(43) Pub. Date: Mar. 14, 2013

(54) DISPLAY APPARATUS AND DISPLAY METHOD

(71) Applicants: Shunichi Shido, Mobara-shi (JP); Takuya Higaki, Chiba-shi (JP); Hideo Mori, Yokohama-shi (JP)

(72) Inventors: Shunichi Shido, Mobara-shi (JP); Takuya Higaki, Chiba-shi (JP); Hideo Mori, Yokohama-shi (JP)

(73) Assignee: CANON KABUSHIKI KAISHA, Tokyo (JP)

(21) Appl. No.: 13/596,148

(22) Filed: Aug. 28, 2012

(30) Foreign Application Priority Data
Sep. 9, 2011 (JP) 2011-197617

(51) Int. Cl. G09G 5/36

(52) U.S. Cl. 345/545

(57) ABSTRACT

A display apparatus comprises: a display screen including pixels, each displaying a natural image and a pattern of a predetermined character, a sign, a graphic or a combination thereof; a pattern memory unit 102 for storing a shape, a display position, a size and a gradation of the pattern, and for storing an accumulated display time of the pattern; a characteristic memory unit 103 for storing a characteristic of luminance lowering of a light emitting element; an accumulated quantity calculating unit 104 for calculating an accumulated quantity of luminance lowering of the pixels constituting the pattern; a correction quantity calculating unit 105 for calculating a correction quantity for each of the pixels constituting the pattern, based on the accumulated quantity of luminance lowering; and an image generating unit 106 for correcting an input image based on the correction quantity, to display a corrected image on the display screen.

### BACKGROUND OF THE INVENTION

1. Field of the Invention

The present invention relates to a display apparatus and a display method for displaying an image on pixels including light emitting elements, and more particularly, to a display apparatus and a display method for displaying an image after correcting the image based on a lowering quantity of luminance.

2. Description of the Related Art

In recent years, light emitting elements (light emitting devices) compatible with a flat panel, such as organic EL elements, are drawing attention. However, the light emitting elements are characterized in that the luminance is lowered by light emission.

For example, when a white fixed pattern is displayed on a black background in a display including a plurality of pixels with light emitting elements arranged in a matrix, black sections do not light up, and the black sections are not degraded. However, white sections light up. Therefore, the white sections are degraded, and the luminance is lowered. The sections with lowered luminance are recognized as burning in subsequent image display, and the image quality is significantly degraded. Particularly, when the display is used as a monitor of a digital camera, fixed patterns, such as icons and texts, indicating imaging conditions are displayed on the monitor. The luminance is easily lowered in the sections where the fixed patterns are displayed, and the sections are easily recognized as burning. Therefore, a technique for correcting the lowering of the luminance of the light emitting elements is demanded. In consideration of the cost, the capacity of a memory that stores data necessary for the correction can be small. In this way, measures for memory errors (such as mirroring of data and addition of a backup memory) can be easily taken.

Japanese Patent Application Laid-Open No. 2011-13470 discloses a technique, in which an integrated time of light-up time of each display mode and average image data assumed as input data of each display mode are used to correct input data for each of the pixels to thereby reduce the capacity of a memory that stores data necessary for the correction.

Although the capacity of the memory can be reduced in the technique described in the document, the assumed average image data of display images in the display modes, such as a monitor mode, a live view mode and various setting modes, is used to predict a degrading quantity. Therefore, efficient correction can be realized in assumed usage in each display mode. However, the effect of the correction may be reduced when a specific pattern is frequently generated in biased usage or in unexpected usage.

If the number of display modes is increased to allow handling the biased usage, there is a problem that the assumed average image data that needs to be stored increases, thereby increasing the capacity of the non-volatile memory.

### SUMMARY OF THE INVENTION

An object of the present invention is to provide a display apparatus and a display method capable of significantly reducing the capacity of a memory and capable of highly accurate correction under any usage.

To solve the problems, the present invention provides a display apparatus including: a display apparatus comprising: a display screen constituted of a plurality of pixels each having a light emitting element for displaying a natural image and a pattern of a character, a sign, a graphic or a combination thereof, the pattern being displayed on a predetermined position of the display screen in a predetermined size and in a predetermined gradation; a pattern memory unit for storing a shape, a position and a size of the pattern, and for storing an accumulated display time of the pattern; a characteristic memory unit for storing a characteristic of luminance lowering of the light emitting element; an accumulated quantity calculating unit for calculating an accumulated quantity of luminance lowering of the pixels constituting the pattern, based on data stored in the pattern memory unit and in the characteristic memory unit; a correction quantity calculating unit for calculating a correction quantity per each of the pixels constituting the pattern, based on the accumulated quantity of luminance lowering; and an image generating unit for correcting an input image data based on the correction quantity, to display a corrected image on the display screen.

The present invention further provides a display method for displaying on a display screen constituted of a plurality of pixels each having a light emitting element, a natural image and a pattern of a character, a sign, a graphic or a combination thereof, the pattern being displayed on a predetermined position of the display screen, in a predetermined size, and in a predetermined gradation, comprising steps of: storing an accumulated display time of the pattern in a memory; calculating an accumulated quantity of luminance lowering per each of the pixels constituting the pattern, based on preliminary prepared data of a characteristic of luminance lowering of the light emitting element, data of a position, a size and a gradation of the pattern and the accumulated display time of the pattern; calculating a correction quantity per each of the pixels displaying the pattern, based on the accumulated quantity of luminance lowering; and correcting an input image based on the correction quantity, to display a corrected image on the display screen.

According to the present invention, burning can be corrected only by storing the shape of the fixed pattern of an icon, the display position, the size, the gradation and the accumulated display time (accumulated appearance time). Therefore, not all light-up history of each pixel needs to be stored, and the capacity of the memory can be significantly reduced. Each fixed pattern, in which burning can be easily recognized, is corrected. Therefore, highly accurate correction is possible.

Further features of the present invention will become apparent from the following description of exemplary embodiments with reference to the attached drawings.

### BRIEF DESCRIPTION OF THE DRAWINGS

FIG. 1 is a block diagram showing a configuration of a display apparatus of the present invention.

FIG. 2A illustrates an example of an image with only patterns, and FIG. 2B illustrates an example of a synthetic image of a natural image and fixed patterns.

FIGS. 3A and 3B are diagrams illustrating an example of a pattern shape and a binary data matrix of the pattern shape.

FIGS. 4A, 4B, 4C, 4D, 4E and 4F are diagrams illustrating examples of pattern shapes, binary data matrices of the pattern shapes and data matrices of the estimated time of luminance lowering.

FIGS. 5A and 5B are diagrams for describing production of a data matrix of the estimated time of luminance lowering.

FIG. 6A is a diagram illustrating an example of luminance lowering characteristics of an organic EL element, and FIG. 6B is a diagram illustrating an example of a correction factor of an organic EL element.

FIG. 7 is a diagram illustrating an example of a control flow based on the present invention.

### DESCRIPTION OF THE EMBODIMENTS

Preferred embodiments of the present invention will now be described in detail in accordance with the accompanying drawings.

Live view display used for focusing in imaging, check monitor display for checking photographed still images or moving images, and set menu display for various settings of a camera are mainly output to a back monitor of a digital still camera or a digital video camcorder. These applications display natural images to be taken (or taken natural images), fixed patterns including numbers and icons for displaying various setting conditions and current use status of the camera, and synthetic images of the natural images and the fixed patterns. Among theses, the fixed patterns are displayed in predetermined shapes, positions, sizes and gradations. Therefore, the luminance of the sections where the fixed patterns are displayed tends to be lowered, which causes burning of the monitor. The fixed patterns are often conspicuously displayed with high luminance to alert the user, and this also accelerates the burning.

Meanwhile, still images taken by cameras and moving images taken in live views and videos are called natural images. High-luminance structures with clear borderlines do not often appear for a long time, and it is known that the images less likely cause visually recognized burning.

In view of the foregoing, the inventors have found out that a great effect of suppressing the burning can be attained by calculating correction quantities of pixels constituting the fixed patterns, such as icons, in an application of a digital camera, etc., and applying the calculated correction quantities to the input image to display the corrected image. In the present invention, the “input image” denotes an image of only a natural image, an image with fixed patterns such as icons, or a synthetic image of the natural image and the fixed patterns. The “natural image” denotes an image other than the fixed patterns such as icons.

An exemplary embodiment of the present invention will now be specifically described with reference to the drawings. Although examples of a display apparatus and a display method for displaying an image on pixels with organic EL elements will be described in the present embodiment, the light emitting elements applicable to the display apparatus and the display method of the present invention are not limited to the organic EL elements.

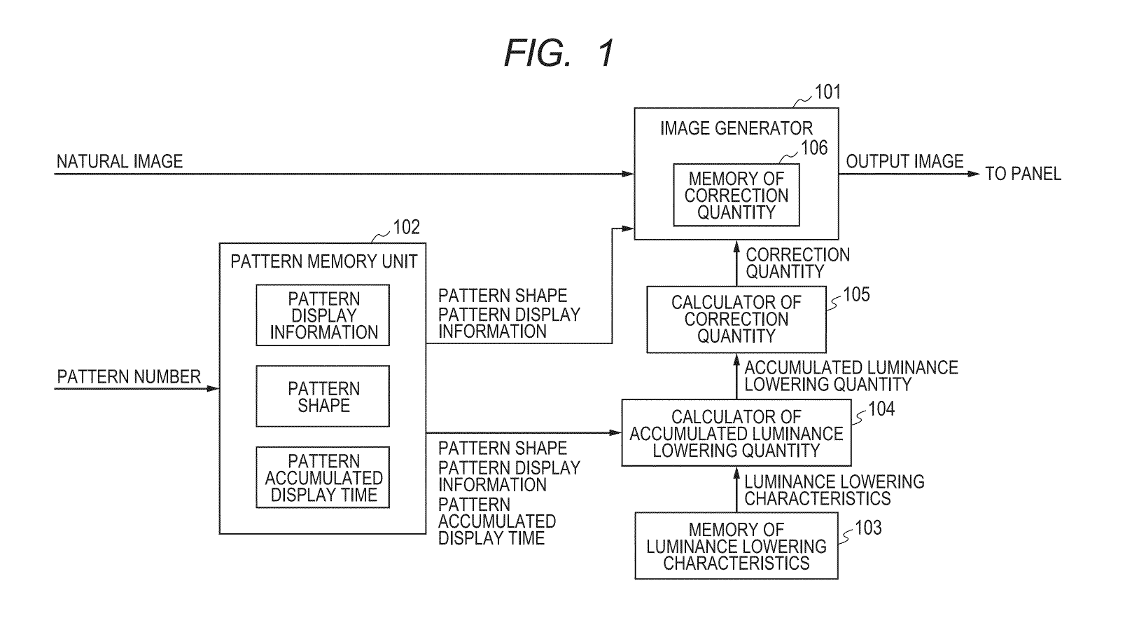

FIG. 1 is a block diagram illustrating an outline of a configuration of the present invention. Information input to a display apparatus includes image data of a natural image after imaging or during live view and numbers (pattern numbers) of fixed patterns (hereinafter, simply “patterns”) displayed in combination with the natural image.

The patterns have attributes such as shapes, display positions, sizes and gradations, and a system of a digital camera, etc., preliminarily prepares the patterns. A small icon displayed at an edge of the screen and a large icon in the same shape displayed at the center are handled as different patterns. The display position of each pattern is predetermined. Therefore, the pixels constituting the patterns are also predetermined.

The patterns may be not only characters, such as “A”, “B”, “0” and “1”, but may also be a combination of the characters. The combination may be a combination of characters, signs, or graphics, or may be a combination of characters and signs, characters and graphics, or signs and graphics.

The shape of the pattern (pattern shape) denotes a shape of the character, the sign or the graphic included in the pattern. In a pattern including two or more characters, signs or graphics, the shape also includes the arrangement of the characters, etc.

The shapes of the patterns are stored in a memory in bitmap format, and addresses of storage positions correspond to indexes (image numbers of Table 1) indicating the shapes of the patterns. A large amount of storage capacity is used if each pattern is stored in bitmap format. Therefore, the shapes of each character, number and sign can be stored in bitmap format, and combinations of addresses of the characters, etc., can be provided to patterns with a plurality of characters, etc.

Pattern numbers are provided to the individual patterns, and data of the shapes, display positions, sizes and gradations is associated.

Table 1 illustrates a data structure of the patterns. “Image Number” of Table 1 denotes indexes of the pattern shapes. “Position” denotes information of the positions on the screen when the patterns are displayed. “Size S” denotes information of the sizes when the patterns are displayed. “Gradation L” denotes information of the gradations when the patterns are displayed. In Table 1, a, b, c, d, k, l, m, n, p, q, r, u, v, w, x, y, N and T are positive integers. The size S and the gradation L include examples of specific values. Data other than “Accumulated Display Time Ts” is predetermined and fixed in the system, and the data is collectively called pattern display information.

TABLE 1

| | | | | | Accumulated |
|---|---|---|---|---|---|
| | Image | | Size | Gradation | Display |
| Pattern | Number | Position | S | L | Time Ts |
| Number | (16) | (16, 16) | (16) | (4) | (32) |
| 1 | p | k, 1 | 1 | 1 | 3 |
| 2 | q | m, n | 1 | 2 | 2 |
| 3 | r | a, b | 2 | 5 | 10 |
| 4 | p | c, d | 6 | 3 | 7 |
| . | . | . | . | . | . |
| . | . | . | . | . | . |
| . | . | . | . | . | . |
| N | u | x, y | v | w | T |

“Accumulated Display Time Ts” of Table 1 denotes an accumulated value of the time of display of the pattern. The system measures the accumulated display time.

“Total Drive Time Tt” of the system may be added to Table 1 as “Pattern Number: 0”.

The display apparatus of FIG. 1 includes an image generating unit 101, a pattern memory unit 102, a characteristic memory unit 103, an accumulated quantity calculating unit 104 and a correction quantity calculating unit 105.

The pattern memory unit 102 stores the pattern display information and the pattern accumulated display time of Table 1 and separately stores the pattern shapes in bitmap format. If the display of a pattern continues for a predetermined time, the pattern accumulated display time is updated by adding the time.

The characteristic memory unit 103 measures, in advance, typical luminance lowering characteristics (lowering quantity of luminance relative to light emission time) of the light emitting elements constituting the pixels and stores the characteristics. The luminance lowering characteristics denote data indicating the relationship between the drive time and the luminance of the pixel. The luminance lower characteristics will be described in detail in a first example.

Non-volatile memories are used to form the pattern memory unit 102 and the characteristic memory unit 103 to store the information even after the power of the display apparatus is turned off.

The accumulated quantity calculating unit 104 reads out the pattern display information, the pattern shapes and the pattern accumulated display time from the pattern memory unit 102 and reads out the luminance lowering characteristics from the characteristic memory unit 103. Based on the read data, the accumulated quantity calculating unit 104 calculates the accumulated quantity of luminance lowering of the pixels constituting the pattern and transmits the calculated values to the correction quantity calculating unit 105.

The correction quantity calculating unit 105 receives the accumulated quantities of luminance lowering calculated by the accumulated quantity calculating unit 104. The correction quantity calculating unit 105 calculates a correction quantity for each of the pixels constituting the pattern and transmits the calculated values to the image generating unit 101.

The image generating unit 101 reads out the pattern display information and the pattern shape from the pattern memory unit 102 and applies the correction quantities calculated by the correction quantity calculating unit 105 to the synthetic image of the natural image and the pattern to be displayed. The image generating unit 101 transmits the image to the panel as an output image and displays the image on a display screen. Only the pixels constituting the pattern are corrected.

The accumulated quantity calculating unit 104 and the correction quantity calculating unit 105 are activated to calculate the correction quantities every time the image data is updated. As described in a subsequent example, the accumulated quantity calculating unit 104 and the correction quantity calculating unit 105 are activated just after the power of the display apparatus is turned on, and the correction quantities calculated at that time may be held during the display operation. In that case, a correction quantity memory unit 106 that stores a data matrix of the correction quantity of each pixel is provided in the image generating unit 101.

The display method of the present invention includes: storing an accumulated display time; calculating an accumulated quantity of luminance lowering; calculating a correction quantity; and correcting an input image based on the correction quantity to display a corrected image on a display screen.

In the storing an accumulated display time, an accumulated value of the display time of the patterns is stored.

In the calculating an accumulated quantity of luminance lowering, the accumulated quantity of luminance lowering of the pixels constituting the pattern is calculated based on the pattern display information, the pattern shape, the pattern accumulated display time and the luminance lowering characteristics.

In the calculating a correction quantity, the correction quantity is calculated for each of the pixels constituting the pattern based on the calculated accumulated quantity of luminance lowering.

In the step of correcting an input image based on the correction quantity to display a corrected image on a display screen, the calculated correction quantity is applied to the synthetic image of the natural image and the pattern to be displayed, and the image is transmitted to the panel as an output image. The output image is displayed on the display screen.

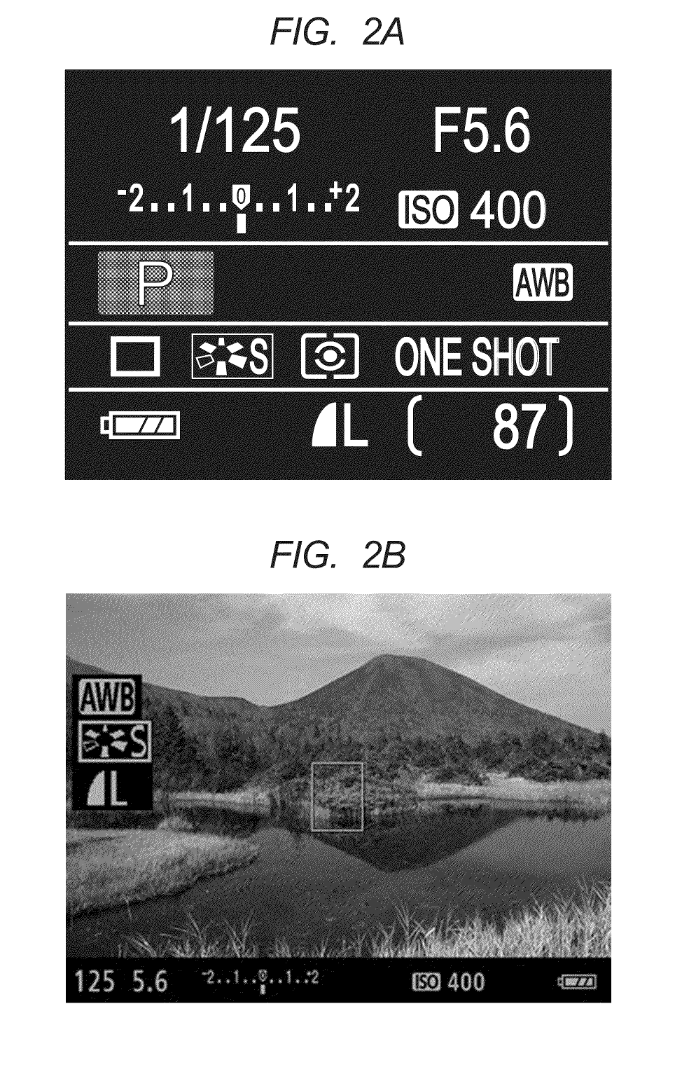

Examples of the patterns will now be illustrated. FIG. 2A illustrates an example of an image with only patterns, and the patterns are arranged on the black background. Meanwhile, FIG. 2B illustrates an example of a synthetic image of a natural image and fixed patterns. “AWB” indicating an auto white balance mode, a rectangle at the center indicating a focus area, as well as “125” and “5.6” indicating various image conditions are the patterns.

Examples of applying the configurations to the display apparatus that includes a plurality of pixels with organic EL elements to correct the input image will be described below.

### First Example

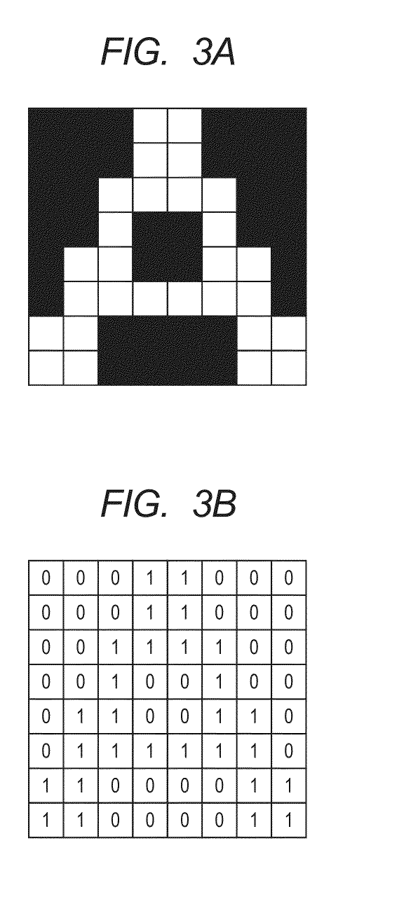

FIG. 3A illustrates image information indicating a character “A” as an example of the pattern shape. White sections are lit up, and black sections are lit down to display the character “A”. Although the size is 8×8 in the example of FIGS. 3A and 3B, the size may be large or small. The pattern shape can actually be binary data, because only the shape is stored. If binary values of 0 and 1 are used, the pattern shape is expressed by a data matrix as illustrated in FIG. 3B. More specifically, the light-up sections are stored as 1, and the light-down sections are stored as 0. The pattern shape as illustrated in FIG. 3A is held in advance by the pattern memory unit 102 (FIG. 1) at the product shipment as image information indicating the shape of a fixed pattern, and the pattern shape is called out in use according to the image number. The pattern shapes may be stored as binary data matrices as described above, or the pattern shapes may be stored after further conversion by image compression or image vectoring.

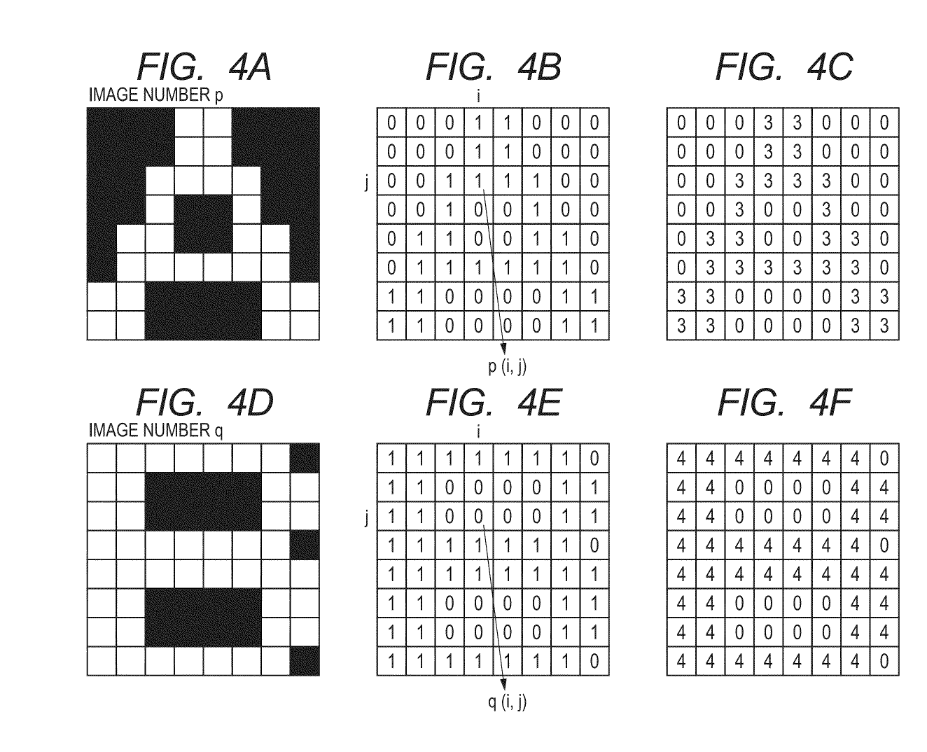

A calculation process of an accumulated quantity of luminance lowering based on the pattern shape, the pattern display information of Table 1, the pattern accumulated display time, and the luminance lowering characteristics, a calculation process of a correction quantity, and a generation process of an output image will be described using examples of two pattern shapes illustrated in FIGS. 4A to 4F.

(Operation of Accumulated Quantity Calculating Unit 104 of Luminance Lowering)

The image number of a first line (pattern number: 1) of Table 1 is p, and FIG. 4A illustrates a pattern shape corresponding to the image number. A binary data matrix of the pattern shape is as illustrated in FIG. 4B, and an element of row j, column i of the data matrix is p(i,j). The element p(i,j) indicates whether the row j, column i of the image number p is lit up. As described, the value is 0 (light down) or 1 (light up).

These are used to calculate an estimated time tᵢⱼ of luminance lowering in the element of row j, column i of the data matrix according to the following expression (1).

tᵢⱼ=p(i,j)×L×Ts (1)

A data matrix constituted by the estimated time tᵢⱼ of luminance lowering is expressed as in FIG. 4C. The values in Table 1 are used for the gradation L and the accumulated display time Ts. A value of integration of the gradation and the accumulated display time of the lit up pattern can be used to calculate the estimated time tᵢⱼ of luminance lowering to convert the gradation L to the estimated time of tᵢⱼ of luminance lowering for evaluation. The luminance lowering characteristics are different in each organic EL element. Therefore, the gradation L needs to be set according to the luminance lowering characteristics of the organic EL elements to perform the conversion.

The size S is used to increase the size of the data matrix of the pattern shape. For example, the size S is 6 in a fourth line (pattern number: 4) of Table 1, and therefore, the image of the image number p is vertically and horizontally increased six times to execute the process in the size (48×48).

The image number of a second line (pattern number: 2) of Table 1 is q, and FIG. 4D illustrates a pattern shape corresponding to the image number. A binary data matrix of the pattern shape is as illustrated in FIG. 4E, and an element of row j, column i of the data matrix is q(i,j). The same process is applied to the pattern number: 2. The q(i,j) data matrix, the gradation L of Table 1, and the accumulated display time Ts are used, and the data matrix constituted by the estimated time tᵢⱼ of luminance lowering is expressed as in FIG. 4F.

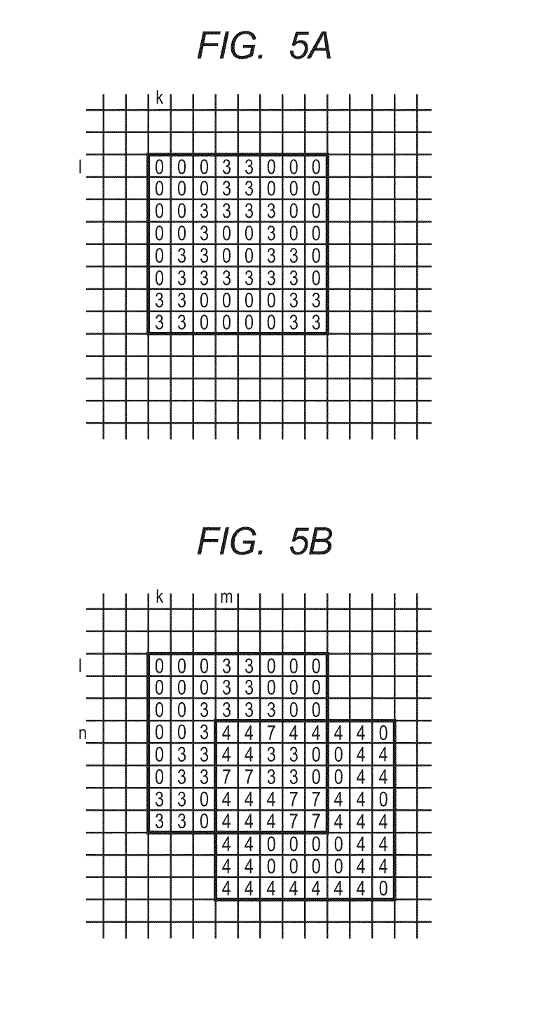

A method of using the data matrix of the estimated time of luminance lowering for development to the pixels of the display will be described with reference to FIGS. 5A and 5B. FIGS. 5A and 5B illustrate part of the display panel, and each mesh indicates the arrangement of the pixel. For example, the overall size is 800×600 pixels in SVGA.

For the pattern number: 1, the data matrix of FIG. 4C is arranged at a position of (k, l) based on Table 1 (FIG. 5A). For the pattern number: 2, the data matrix of FIG. 4F is arranged at a position of (m, n), and in the sections where the data matrices overlap, the elements, i.e. the estimated times of luminance lowering, are added (FIG. 5B). In this way, appropriate estimated time of luminance lowering can be calculated even if various patterns are displayed on top of each other. If the addition process is sequentially applied to all patterns to be displayed, a data matrix of the estimated time of luminance lowering according to the use history is calculated. This allows estimating how much load is imposed on each pixel by the pattern display.

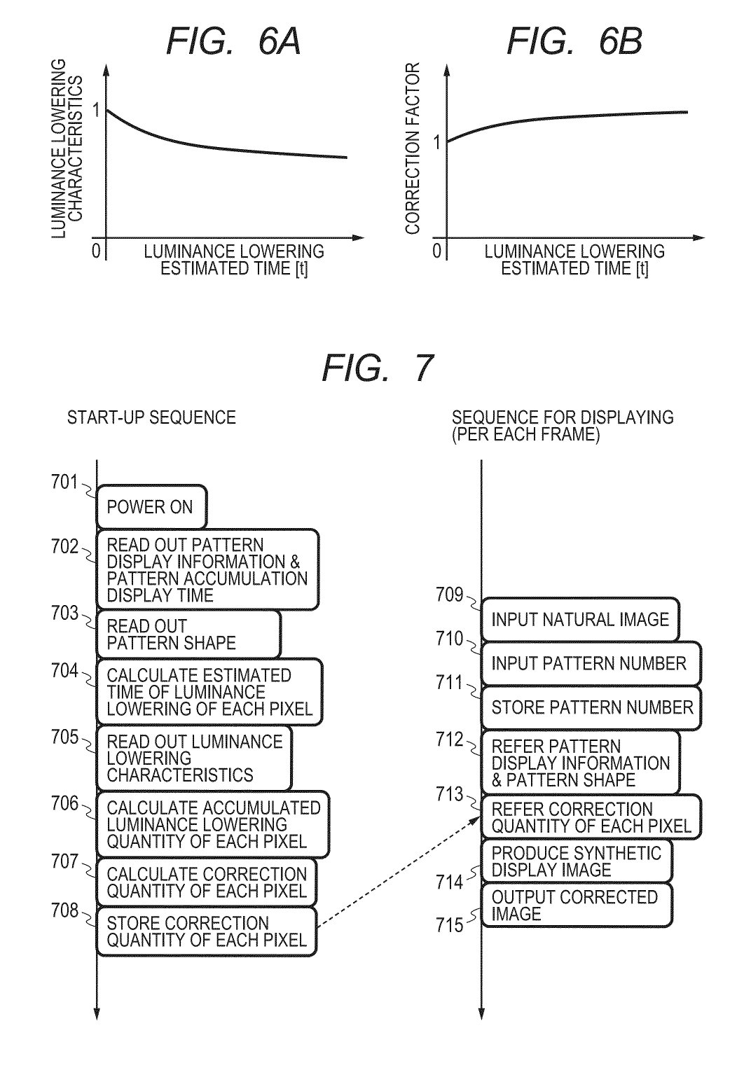

A procedure of estimating an accumulated quantity of luminance lowering from the estimated time of luminance lowering will be described. The characteristic memory unit 103 of FIG. 1 holds luminance lowering characteristics relative to the estimated time of luminance lowering as in FIG. 6A. The luminance lowering characteristics are used to estimate the accumulated quantity of luminance lowering for the value of each pixel in the data matrix of the above estimated time of luminance lowering. As a result, a data matrix of the accumulated quantity of luminance lowering of each pixel is formed.

(Operation of Correction Quantity Calculating Unit 105)

A correction quantity data matrix is produced based on the data matrix of the accumulated quantity of luminance lowering, and a correction signal is transmitted to the image generating unit 101 of FIG. 1. To calculate the correction quantity data matrix from the accumulated quantity of luminance lowering, correction is applied to return the output to 1 based on the luminance lowering characteristics of FIG. 6A. More specifically, a reciprocal of luminance lowering of FIG. 6A is calculated to form the correction quantity data matrix. Instead of storing the luminance lowering characteristics, a value of a correction factor relative to the estimated time of luminance lowering can be stored in advance and used as correction characteristics as illustrated in FIG. 6B.

The influence of the load caused by the correction can be taken into account for the luminance lowering characteristics. The luminance lowering characteristics of the organic EL elements are generally obtained by applying a predetermined current or a predetermined voltage. This is because constant current drive or constant voltage drive is performed when the organic EL elements are used as display devices. However, the drive when the luminance is corrected is not based on a predetermined voltage or a predetermined current. More specifically, luminance lowering characteristics based on efficiency degrading characteristics due to predetermined luminance are necessary, and the correction factor is calculated from the thus obtained luminance lowering characteristics.

(Operation of Image Generating Unit 101)

The correction data matrix is applied to the image formed by the natural image and the fixed pattern information to correct the output image, and the corrected image is output to the panel. This completes the correction.

An example of a procedure of a correction process and a data storage process will be illustrated with reference to FIG. 7. As already described, the luminance of a display using light emitting elements, such as organic EL elements, is lowered due to light emission. However, the change is generally slow, with a long time constant on some level. Therefore, there isn't much need to feed back the drive load to the correction in real time in intermittent drive as in a digital camera. Thus, an effective method in the present example is to determine the correction quantity to be used in the drive of that time when the power is turned on and not to change the correction quantity during the actual drive. In this way, the amount of calculation can be reduced, and the power consumption associated with the calculation can also be reduced.

FIG. 7 illustrates a flow of the control of the present example. FIG. 7 (701 to 708) illustrates a process sequence when the display apparatus is started up, and FIG. 7 (709 to 715) illustrates a process sequence in each frame during display operation.

Operation when the display apparatus is started up (power on) will be described first.

After the power is turned on (701), the pattern display information and the pattern accumulated display time stored in previous drives are read out from the pattern memory unit 102 (702). Subsequently, the pattern shapes corresponding to the data are sequentially read out from the pattern memory unit 102 (703), and the accumulated quantity calculating unit 104 of luminance lowering uses the data to calculate the estimated time of luminance lowering of the pixels that display the patterns (704). The accumulated quantity calculating unit 104 of luminance lowering further reads out the preliminary prepared luminance lowering characteristics from the characteristic memory unit 103 (705) and calculates the accumulated quantity of luminance lowering of the pixels that display the patterns based on the data and the estimated time of luminance lowering (706). Based on the calculated accumulated quantity of luminance lowering, the correction quantity calculating unit 105 calculates the correction quantity for each of the pixels that display the patterns (707), and the correction quantity memory unit arranged in the display apparatus stores the calculated correction quantity (708). The calculated correction quantity can be held only when the power is on, and there is no need to store the correction quantity in a non-volatile memory. The correction quantity memory unit may not be included.

Operation of display of each frame will now be described.

When the frame operation is started, the natural image and the pattern number are input (709, 710). The pattern number is stored in the pattern memory unit 102 (711). The pattern memory unit 102 holds a display history, which needs to be held when the power is off. Therefore, the pattern memory unit 102 is formed by a non-volatile memory. The image generating unit 101 refers to the pattern display information and the pattern shape corresponding to the pattern number (712) and refers to the correction quantity for each of the pixels that display the patterns held at the start-up (713). An image is synthesized from the natural image, the pattern display information and the pattern shape (714). The correction quantity for each of the pixels that display the patterns is applied to the synthetic image to produce an output image. The image is output to the panel (715) to end the sequence of each frame.

An amount of non-volatile memory necessary in the present example will be described.

The information held by the non-volatile memory in the system includes the pattern display information of Table 1 necessary to store the display history, the pattern accumulated display time, the pattern shape and the luminance lowering characteristics. The pattern display information and the pattern accumulated display time can be realized by about the numbers of bits illustrated in the parentheses of Table 1. The image number includes 16 bits, the position includes 16×2=32 bits, the size S includes 16 bits, the gradation L includes 4 bits, the display time Ts includes 32 bits, and the total is 100 bits. If the number N of pattern numbers is about 100, the total is 1.25 kB (kilobytes). The pattern shape includes 8×8=64 bits in the data matrix illustrated in FIG. 3B, and even if the pattern shape is larger, the pattern shape includes, for example, 32×32=1024 bits. Even if there are 100 patterns of the size, the memory size is about 13 kB. As already described, the binary data matrix as illustrated in FIG. 3B can be reduced several times smaller by image compression or vectoring. Even if the data matrix is not compressed, the data matrix in conjunction with the pattern display information includes about 15 kB. The capacity is 15×3=45 kB even if RGB are taken into account.

Meanwhile, in the same display of SVGA, the necessary memory capacity when the light-up time data is integrated per each pixel is 32 bits of time information per each pixel (as in Table 1) and 4 bits of gradation information (as in Table 1), and the number of pixels is 800×600. Therefore, the necessary memory capacity is (32+4)×600×800=17280000 bits (2.16 MB). If three RGB colors are taken into account, a memory of three times, or 6.6 MB, is necessary.

In another method, when assumed average image data of each display mode is held as described in Japanese Patent Application Laid-Open No. 2011-13470, the assumed average image data of each display mode in the display of SVGA includes 8×800×600=3840000 bits (480 kB) per screen. If three RGB colors are taken into account, the data includes three times of the bits, or 1.44 MB/mode. Compared to this, it can be understood that the present invention can significantly reduce the memory capacity as a result of storing the accumulated display time of the patterns.

When the correction is applied according to the example, it is recognized that the burning quantity caused by the fixed patterns is 1% or less at the maximum. Therefore, the luminance lowering quantity relative to the drive time is 1% or less.

### Second Example

An example will be illustrated as a method of further improving the accuracy of the correction, wherein the calculation method of the estimated time of luminance lowering of the first example is changed.

When a panel with organic EL elements is driven as a back monitor of, for example, a digital camera or a digital video camcorder, an image equivalent to a natural image is displayed if the patterns are not displayed. As already described, although visually recognized burning is unlikely to occur in the natural image, the organic EL elements are degraded even if the natural image is displayed. Therefore, the luminance lowering quantity during the natural image display needs to be taken into account to further improve the correction accuracy.

In an application of a digital camera, etc., the natural image is often displayed when the patterns are not displayed, and the display time of the natural image is Tn≈Tt−Ts. Tt denotes a total drive time of the system. When the average luminance of the natural image is Ln, the data matrix of an estimated time Tᵢⱼ′ of luminance lowering can be determined from the following Expression (2).

tᵢⱼ′=p(i,j)×L×Ts+(Tt−Tn)×Ln (2)

Ln has a gradation equivalent to the average luminance of images taken by a digital camera and moving images of a live view, etc. As a result of examination based on several thousand sample still images, the average luminance is about 20% of the maximum luminance in an application of a digital camera. Therefore, Ln is set to about 20% of the maximum luminance, and the estimated time tᵢⱼ′ of luminance lowering is calculated based on an addition of a value of integration of the gradation of the lit up patterns and the accumulated display time and a value of integration of the display time with only the natural image and the average luminance of the natural image. The correction is applied based on the calculated estimated time tᵢⱼ′ of luminance lowering, and it is recognized that the burning quantity caused by the fixed patterns is 0.5% at the maximum. Therefore, the luminance lowering quantity relative to the drive time is 0.5%.

Ln described above varies depending on the application of the digital camera or the digital video camcorder. In the present example, although Ln is used in the digital camera, the value of Ln can be changed when used in another apparatus such as a digital video camcorder.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-197617, filed Sep. 9, 2011, which is hereby incorporated by reference herein in its entirety.

What is claimed is:

1. A display apparatus comprising:
a display screen constituted of a plurality of pixels each having a light emitting element for displaying a natural image and a pattern of a character, a sign, a graphic or a combination thereof, the pattern having a predetermined shape, a predetermined position in the display screen, a predetermined size and a predetermined gradation;
a pattern memory unit for storing data of the shape, the position, the size and the gradation of the pattern, and for storing data of an accumulated display time of the pattern;
a characteristic memory unit for storing data of a characteristic of luminance lowering of the light emitting element;
an accumulated quantity calculating unit for calculating an accumulated quantity of luminance lowering of the pixels constituting the pattern, based on the data stored in the pattern memory unit and in the characteristic memory unit;
a correction quantity calculating unit for calculating a correction quantity for each of the pixels constituting the pattern, based on the accumulated quantity of luminance lowering; and
an image generating unit for correcting an input image data based on the correction quantity, to display a corrected image on the display screen.

2. The display apparatus according to claim 1, further comprising
a correction quantity memory for storing the correction quantity calculated.

3. The display apparatus according to claim 1, wherein
the accumulated quantity calculating unit calculates an estimated time of luminance lowering of the pixels constituting the pattern, to calculate the accumulated quantity of luminance lowering based on the estimated time of luminance lowering calculated.

4. The display apparatus according to claim 3, wherein
the accumulated quantity calculating unit calculates the estimated time of luminance lowering, based on a value of integration of the gradation by the accumulated display time of the pattern.

5. The display apparatus according to claim 3, wherein
the accumulated quantity calculating unit calculates the estimated time of luminance lowering, based on a sum of a value of integration of the gradation by the accumulated display time of the pattern and a value of integration of an average luminance of the natural image by an accumulated time of displaying only the natural image.

6. An imaging apparatus comprising:
a monitor including display apparatus according to claim 1, wherein
the pattern is an icon or a text displayed on the display screen, which indicates an imaging condition of the imaging apparatus.

7. A display method for displaying on a display screen constituted of a plurality of pixels each having a light emitting element, a natural image and a pattern of a character, a sign, a graphic or a combination thereof, the pattern having a predetermined shape, a predetermined position in the display screen a predetermined size and a predetermined gradation, comprising steps of:
preparing data of the shape, the position, the size and the gradation of the pattern, and data of a characteristic of luminance lowering of the light emitting element;
storing data of an accumulated display time of the pattern in a memory;
calculating an accumulated quantity of luminance lowering of the pixels constituting the pattern, based on the prepared data of a characteristic of luminance lowering of the light emitting element and the prepared data of the shape, the position, the size and the gradation of the pattern and the accumulated display time of the pattern;
calculating a correction quantity for each of the pixels displaying the pattern, based on the accumulated quantity of luminance lowering; and
correcting an input image based on the correction quantity, to display a corrected image on the display screen.
